(19) United States
(12) Patent Application Publication
(10) Pub. No.: US 2026/0218857 A1
(43) Pub. Date: Jul. 30, 2026

(54) HYDROGEN GAS TRANSPORT DEVICE AND PURGING METHOD FOR COMPRESSOR

(71) Applicant: KAWASAKI JUKOGYO KABUSHIKI KAISHA, Kobe-shi, Hyogo (JP)

(72) Inventors: Yuki HACHIMURA, Kobe-shi, Hyogo (JP); Munemitsu NOMURA, Kobe-shi, Hyogo (JP); Taizou KOBAYASHI, Kobe-shi, Hyogo (JP)

(73) Assignee: KAWASAKI JUKOGYO KABUSHIKI KAISHA, Kobe-shi, Hyogo (JP)

(21) Appl. No.: 19/146,221

(22) PCT Filed: Dec. 21, 2023
(86) PCT No.: PCT/JP2023/045915

§ 371 Date: Jul. 8, 2025

(30) Foreign Application Priority Data
Jan. 10, 2023 (JP) 2023-001855

(51) Int. Cl. F17C 7/00; F17C 13/02

(52) U.S. Cl. CPC F17C 7/00; F17C 13/025; F17C 2221/012; F17C 2223/0123; F17C 2227/0164; F17C 2227/044; F17C 2250/0434

(57) ABSTRACT

A hydrogen gas transport apparatus includes a transport pipe for hydrogen gas and a compressor that sends out the hydrogen gas. The compressor includes: a drive source; a compression chamber that is connected to the transport pipe; a drive shaft that connects the drive source and the compression element; and a housing that accommodates the drive shaft. The housing has a first purging chamber that receives supply of the hydrogen gas, and a second purging chamber that receives supply of inert gas. The hydrogen gas transport apparatus includes: a first purging pipe that supplies the hydrogen gas to the first purging chamber; and a second purging pipe that supplies the hydrogen gas from a predetermined hydrogen gas supply source to the first purging chamber when the detector detects a pressure reduction, each purging pipe serving as a supply passage for the hydrogen gas for purging.

### TECHNICAL FIELD

The present disclosure relates to a hydrogen gas transport apparatus including a compressor incorporated in a transport pipe, and a purging method for the compressor.

### BACKGROUND ART

A transport system for hydrogen gas can be established with a transport pipe and a compressor incorporated in the transport pipe to compress and send out the hydrogen gas. For instance, Patent Literature 1 discloses a way of returning Boil Off Gas (hereinafter, referred to as “BOG”) generated in a storage tank for liquefied hydrogen to a liquefier by a transport system including a BOG transport pipe and a compressor (e.g., Patent Literature 1).

The compressor typically includes: a compression chamber including a compression element, such as a piston or a turbine; and a drive shaft that transmits a drive force to the compression element. The drive shaft is covered with a housing that allows purge gas to flow therein. In a structure to send hydrogen gas to the transport pipe, the housing may be divided by a partition into a first purging chamber being adjacent to the compression chamber and a second purging chamber being adjacent to the first purging chamber, and the drive shaft may penetrate through the partition. In this structure, the first purging chamber receives supply of the hydrogen gas as purge gas, and the second purging chamber receives supply of inert gas, such as nitrogen gas, to be separated from the atmosphere and the hydrogen gas.

A general and rational configuration makes hydrogen gas serving as purge gas be taken out from the transport pipe located around the compressor. Unfortunately, adoption of this configuration leads to a pressure reduction in the hydrogen gas in the first purging chamber when the compressor is suspended. Thus, the inert gas in the second purging chamber may pass along a penetration portion of the drive shaft through the partition as an impurity, and may advance into the compression chamber and further enter the transport pipe. This configuration hence has a concern about flowing of hydrogen gas that contains the impurity to a transport destination, resulting in having a negative influence on various devices connected to the transport pipe.

### CITATION LIST

### Patent Literature

Patent Literature 1: Japanese Unexamined Patent Publication No. 2016-196977

### SUMMARY OF INVENTION

An object of the present disclosure is to provide a hydrogen gas transport apparatus and a purging method for a compressor to each achieve deterrence of entering of inert gas, which is to be supplied for purging to a housing covering a drive shaft of the compressor, into a transport pipe for hydrogen gas.

A hydrogen gas transport apparatus according to an aspect of the present disclosure includes: a transport pipe for hydrogen gas; a compressor that is located at the transport pipe and sends out the hydrogen gas. The compressor includes: a drive source; a compression chamber that includes a compression element for the hydrogen gas and is connected to the transport pipe; a drive shaft that connects the drive source and the compression element to each other; and a housing that accommodates the drive shaft, the housing having a first purging chamber that is adjacent to the compression chamber and receives supply of the hydrogen gas as purge gas, a second purging chamber that is adjacent to the first purging chamber and receives supply of inert gas as purge gas, a first partition that separates the compression chamber and the first purging chamber from each other, and a second partition that separates the first purging chamber and the second purging chamber from each other, the drive shaft penetrating through the first partition and the second partition and being provided with a first shaft seal at a penetration portion of the drive shaft through the first partition and a second shaft seal at a penetration portion of the drive shaft through the second partition. The hydrogen gas transport apparatus includes: a detector that detects a pressure reduction in the transport pipe; a first purging pipe that branches from the transport pipe and supplies the hydrogen gas to the first purging chamber; a second purging pipe that supplies the hydrogen gas from a predetermined hydrogen gas supply source to the first purging chamber when the detector detects the pressure reduction; and a third purging pipe that supplies the inert gas to the second purging chamber.

A purging method for a compressor according to another aspect of the present disclosure is a purging method for a compressor that is provided at a transport pipe for hydrogen gas and sends out the hydrogen gas. The compressor includes: a drive source; a compression chamber that includes a compression element for the hydrogen gas and is connected to the transport pipe; a drive shaft that connects the drive source and the compression element to each other; and a housing that accommodates the drive shaft, the housing having a first purging chamber that is adjacent to the compression chamber and receives supply of the hydrogen gas as purge gas, a second purging chamber that is adjacent to the first purging chamber and receives supply of inert gas as purge gas, a first partition that separates the compression chamber and the first purging chamber from each other, and a second partition that separates the first purging chamber and the second purging chamber from each other, the drive shaft penetrating through the first partition and the second partition and being provided with a first shaft seal at a penetration portion of the drive shaft through the first partition and a second shaft seal at a penetration portion of the drive shaft through the second partition. The purging method includes: supplying the hydrogen gas to the first purging chamber from a first purging pipe branching from the transport pipe when no pressure reduction is detected in the transport pipe; supplying the hydrogen gas to the first purging chamber from a second purging pipe communicating with a predetermined hydrogen gas supply source when a pressure reduction is detected in the transport pipe; and supplying inert gas to the second purging chamber through a third purging pipe.

The present disclosure achieves deterrence of entering of inert gas, which is to be supplied for purging to a housing covering a drive shaft of a compressor, into a transport pipe for hydrogen gas in a hydrogen gas transport apparatus.

### BRIEF DESCRIPTION OF DRAWINGS

FIG. 1 is a system diagram illustrating a hydrogen gas transport line for which a hydrogen gas transport apparatus according to the present disclosure is adoptable.

FIG. 2 is a system diagram illustrating a configuration of a hydrogen gas transport apparatus according to a comparative example.

FIG. 3 is a system diagram illustrating a configuration of the hydrogen gas transport apparatus according to the present disclosure.

FIG. 4 is a block diagram illustrating a control configuration of the hydrogen gas transport apparatus.

FIG. 5A and FIG. 5B are each a system diagram illustrating an example arrangement of a second purging pipe that supplies hydrogen gas for purging.

### DESCRIPTION OF EMBODIMENTS

Hereinafter, an embodiment of a hydrogen gas transport apparatus according to the disclosure will be described with reference to the accompanying drawings. The hydrogen gas transport apparatus according to the present disclosure is adoptable for various facilities each requiring transport of hydrogen gas with a compressor. For instance, the hydrogen gas transport apparatus according to the present disclosure is adoptable for a line to send hydrogen gas from a hydrogen gas tank serving as a hydrogen gas generation source to a hydrogen gas usage facility, such as a power plant, in cooperation with a compressor. Alternatively, for example, the hydrogen gas generation source is defined as a BOG generation source. In this example, the hydrogen gas transport apparatus according to the present disclosure is adoptable for a line to return BOG generated in a production facility for liquefied hydrogen to a liquefier, a line to collect BOG generated at loading of produced liquefied hydrogen to a carrier or a lorry, a line to collect the BOG generated at the loading of the liquefied hydrogen to a destination facility for the liquefied hydrogen, or other line

### [Hydrogen Gas Transport Line]

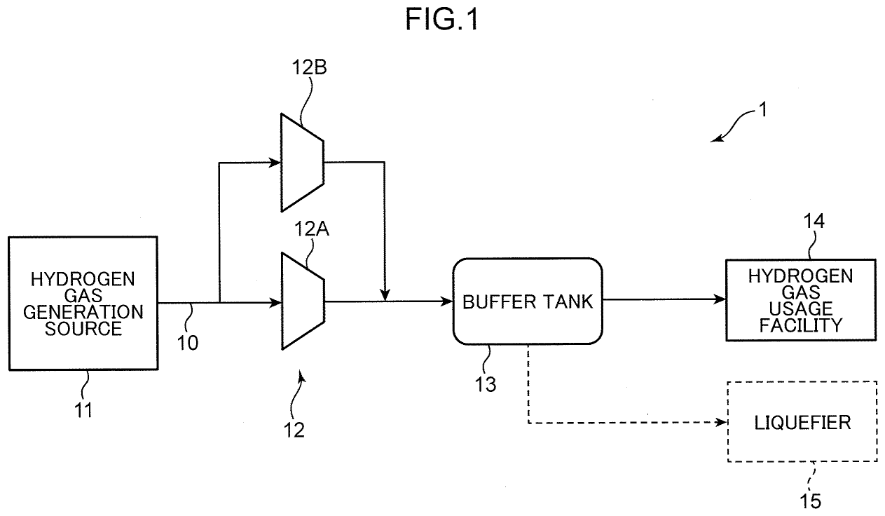

FIG. 1 is a system diagram illustrating a hydrogen gas transport line 1 for which a hydrogen gas transport apparatus according to the present disclosure is adoptable. The hydrogen gas transport line 1 illustrated in FIG. 1 includes a transport pipe 10 for hydrogen gas, and a hydrogen gas generation source 11, a compressor 12, a buffer tank 13, and a hydrogen gas usage facility 14 arranged in this order at the transport pipe 10.

The transport pipe 10 enables transport of the hydrogen gas therethrough. The transport pipe 10 may have a heat insulation outer layer or a vacuum heat insulation structure as needed. The hydrogen gas generation source 11 represents a hydrogen-related facility, e.g., a liquefied hydrogen tank provided on a land, a liquefied hydrogen storage tank included in a hydrogen carrier, or a transport pipe for liquefied hydrogen. Hydrogen gas supplied from such a facility, or BOG generated at evaporation of liquefied hydrogen through heat input into the facility serves as a transport target of the transport pipe 10. Here, the transport target of the transport pipe 10 is not limited to the hydrogen gas or the BOG to be supplied from the aforementioned hydrogen-related facility having a very low temperature. For instance, a facility that produces hydrogen gas through water electrolysis or reforming of a fossil fuel may serve as the hydrogen gas generation source 11, and the hydrogen gas produced in the facility may be defined as the transport target of the transport pipe 10.

The compressor 12 is a device to take in hydrogen gas (BOG) from the transport pipe 10 at an upstream position thereof, compress the hydrogen gas, and send the compressed hydrogen gas out toward a downstream position of the transport pipe 10. FIG. 1 illustrates an example of two compressors 12 of the first compressor 12A and the second compressor 12B incorporated in the transport pipe 10 parallel to each other. Each compressor 12 may be a reciprocating compressor to be exemplified later, a centrifugal compressor including an impeller, or other compressor.

The buffer tank 13 temporarily stores the hydrogen gas sent from the compressor 12 to absorb a pressure fluctuation. Examples of the hydrogen gas usage facility 14 include an electric power generating facility that utilizes hydrogen gas.

An example of adapting the hydrogen gas transport line 1 to a gas sending line to send hydrogen gas on a destination site of the liquefied hydrogen will be described. At regular sending of gas to the hydrogen gas usage facility 14, the first compressor 12A is operated to send out the hydrogen gas while the second compressor 12B is suspended. By contrast, a large amount of BOG is generated at the hydrogen gas generation source 11 at loading of the liquefied hydrogen. In such a situation, both the first and second compressors 12A and 12B are operated to transport the hydrogen gas containing the BOG in the transport pipe 10. In other words, the first compressor 12A works as a regular-use compressor, and the second compressor 12B works as an emergency-use compressor to be operated only at transport of such a large amount of the BOG.

In a case where the hydrogen gas transport line 1 is adapted to a BOG collecting line on a production and delivery site for liquefied hydrogen, the buffer tank 13 is connected to a liquefier 15 at a downstream position thereof in place of the hydrogen gas usage facility 14, as denoted by a dotted line in FIG. 1. That is to say, the hydrogen gas transport line 1 serves as a transport line to re-liquefy the BOG generated in the hydrogen-related facility. The BOG generated at evaporation of the liquefied hydrogen through heat input into the facility serves as a transport target of the transport pipe 10.

The liquefier 15 is a device to give cold heat to the BOG to re-liquefy the BOG. The liquefier 15 includes: heat exchangers that cool the BOG by utilizing hydrogen gas or nitrogen gas as a coolant; and an expansion turbine and an expansion valve that reduce the pressure of the BOG increased by the compressor 12 to liquefy the BOG. For instance, in a case where the hydrogen gas transport line 1 is adopted for the production and delivery site for the liquefied hydrogen, a liquefied hydrogen storage tank, a delivery loading pipe, and other element are connected to the liquefier 15 at downstream positions thereof.

When the hydrogen gas transport line 1 is adapted to the BOG collecting line, the BOG generated in the transport pipe 10 or a liquefied hydrogen storage tank at a downstream position of the liquefier 15 serves as BOG to be sent out from the hydrogen gas generation source 11 to the compressor 12 in FIG. 1. An amount of the BOG generated at regular production of the liquefied hydrogen is not so large. In this situation, the first compressor 12A is operated to send out the BOG while the second compressor 12B is suspended. By contrast, a large amount of BOG is generated at loading of the liquefied hydrogen for delivery. In such a situation, both the first and second compressors 12A and 12B are operated to transport the BOG in the transport pipe 10. In other words, the first compressor 12A works as a regular-use compressor, and the second compressor 12B works as an emergency-use compressor to be operated only at transport of such a large amount of the BOG.

As described above, the second compressor 12B to work as the emergency-use compressor is repetitively operated and suspended. Besides, the second compressor 12B for emergency-use is temporarily operated when the first compressor 12A for regular-use has any defect, such as a malfunction, or needs maintenance, and the second compressor is suspended again after the defect is removed. Such a compressor 12 as to be intermittently operated and suspended have a disadvantage of a reduction in a purging effect which will be described below. [Hydrogen gas transport apparatus in a comparative example]

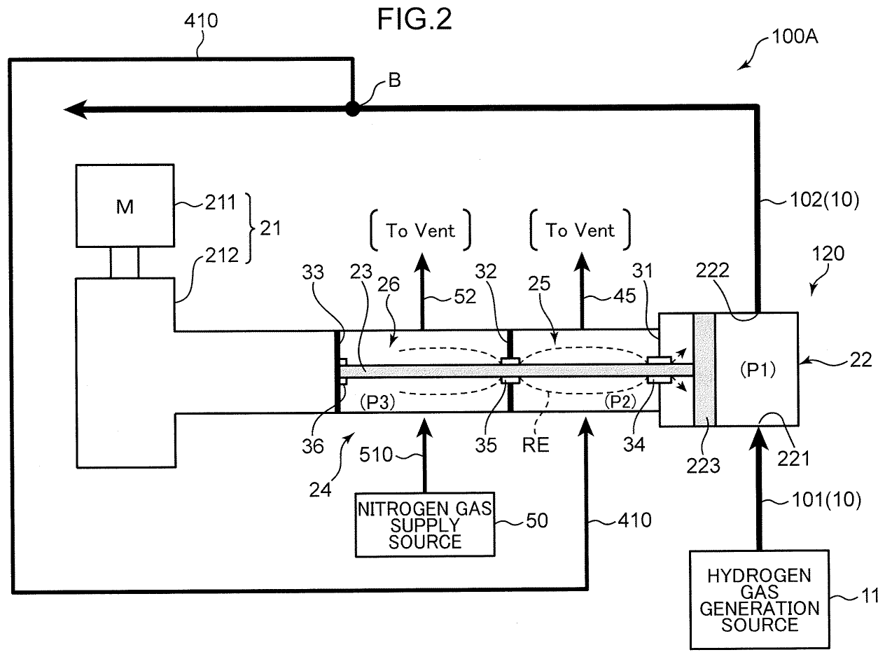

FIG. 2 is a system diagram illustrating a configuration of a hydrogen gas transport apparatus 100A including a compressor 120 having a purging structure in a comparative example. The drawing exemplifies the compressor 120 of a reciprocating type. A transport pipe 10 serving as a process line is required to avoid entering of an impurity, such as nitrogen gas, thereinto as much as possible. For instance, a certain hydrogen gas usage facility 14 may limit a concentration of such an impurity that mixes into hydrogen gas to be sent through the transport pipe 10 to approximately 10 ppm. The compressor 120 is a device directly incorporated in the transport pipe 10. The compressor 120 is hence provided with a purging structure that utilizes hydrogen gas as purge gas to deter the impurity from entering through the compressor 120. Hydrogen gas (BOG) flowing in the transport pipe 10 is adopted as the hydrogen gas to serve as purge gas.

The configuration of the compressor 120 including the purging structure will be described in detail. The compressor 120 includes a drive source 21, a compression chamber 22, a drive shaft 23, and a housing 24. The drive source 21 is a generation source to generate a drive force of the compressor 120, and includes a prime mover 211 and a crank chamber 212. The prime mover 211 is a rotational force generator, such as a motor. The crank chamber 212 is a housing accommodating a crank mechanism that converts a rotational movement of an output shaft of the prime mover 211 into a reciprocating movement, and accommodates a crank shaft and a connecting rod.

The compression chamber 22 is a cylinder to compress the hydrogen gas, and has an inlet 221 and an outlet 222 for the hydrogen gas. The transport pipe 10 has an upstream pipe 101 connected to the inlet 221, and the inlet 221 communicates with the hydrogen gas generation source 11. The transport pipe 10 has a downstream pipe 102 connected to the outlet 222. The downstream pipe 102 receives the hydrogen gas compressed by the compressor 120 and sent therefrom. The compression chamber 22 accommodates a piston 223 that serves as a compression element and reciprocates. The piston 223 reciprocates to compress the hydrogen gas having entered the compression chamber 22. The drive shaft 23 connects the crank mechanism of the crank chamber 212 and the piston 223 to each other, and transmits the reciprocating movement of the crank mechanism to the piston 223.

The housing 24 is a closed housing that accommodates the drive shaft 23. The housing 24 has a first purging chamber 25 being adjacent to the compression chamber 22 and a second purging chamber 26 being adjacent to a side surface of the first purging chamber 25 that is closer to the drive source 21. The first purging chamber 25 receives supply of the hydrogen gas as purge gas. The second purging chamber 26 receives supply of inert gas as purge gas. In the embodiment, nitrogen gas is selected as the inert gas.

The compression chamber 22 and the first purging chamber 25 are separated from each other by a first partition 31. The first purging chamber 25 and the second purging chamber 26 are separated from each other by a second partition 32, and the second purging chamber 26 and the crank chamber 212 are separated from each other by a third partition 33. The drive shaft 23 penetrates through the three partitions of the first partition 31, the second partition 32, and the third partition 33. The drive shaft 23 is provided with a first shaft seal 34 to ensure sealing performance at a penetrating portion of the drive shaft through the first partition 31. Similarly, the drive shaft 23 is provided with a second shaft seal 35 at a penetrating portion of the drive shaft through the second partition 32, and a third shaft seal 36 at a penetrating portion of the drive shaft through the third partition 33.

The first purging chamber 25 receives supply of the hydrogen gas as purge gas through a hydrogen gas purging pipe 410. The hydrogen gas purging pipe 410 branches from the transport pipe 10 at a branch section B of the transport pipe 10 that is located at a downstream position of the compressor 120. The hydrogen gas purging pipe 410 has a downstream end connected to an introduction opening at the first purging chamber 25. Specifically, a part of BOG having a pressure increased by the compressor 120 to be a transport target of the transport pipe 10 is taken out from the transport pipe 10 as purge gas. The compressor 120 in an operation state allows the hydrogen gas to flow from the hydrogen gas purging pipe 410 into the first purging chamber 25. The first purging chamber 25 has a discharge opening connected to a discharge pipe 45 to discharge the hydrogen gas used for purging.

The second purging chamber 26 receives supply of nitrogen gas as purge gas through a nitrogen gas purging pipe 510. The nitrogen gas purging pipe 510 has an upstream end connected to a nitrogen gas supply source 50, such as a tank, storing nitrogen gas for purging, and has a downstream end connected to the introduction opening at the second purging chamber 26. The second purging chamber 26 has a discharge opening connected to a discharge pipe 52 to discharge the nitrogen gas used for purging. Interposition of the second purging chamber 26 enables avoidance of direct contact between the hydrogen gas in the first purging chamber 25 and the air in the crank chamber 212.

During the operation of the compressor 120, a pressure in the compression chamber 22, that is, a pressure to send out the BOG to the downstream pipe 102 of the transport pipe 10, is defined as a predetermined pressure P1. By contrast, a pressure P2 in the first purging chamber 25 is defined to be a smaller value than P1. Besides, a pressure P3 in the second purging chamber 26 is defined to be a smaller value than P2. Specifically, a pressure relation among the three pressures is defined as “P1>P2>P3” during the operation of the hydrogen gas transport apparatus 100A. Such definition of the pressure relation prevents the nitrogen gas existing in the second purging chamber 26 from advancing into the compression chamber 22 through the second shaft seal 35 and the first shaft seal 34.

However, the pressure relation would not be satisfied due to suspension of the compressor 120 or a significant reduction in a sending-out pressure. Specifically, when the compressor 120 is suspended, the hydrogen gas is not supplied to the hydrogen gas purging pipe 410. This results in reducing the pressure P2 in the first purging chamber 25. Needless to say, the pressure P1 in the compression chamber 22 also reduces. As denoted by a callout line RE in FIG. 2, the nitrogen gas existing in the second purging chamber 26 may advance into the compression chamber 22 through the second shaft seal 35 at the second partition 32 and the first shaft seal 34 at the first partition 31. The nitrogen gas having advanced into the compression chamber 22 may further enter the transport pipe 10, resulting in having a negative influence on the hydrogen gas usage facility 14 and the liquefier 15 connected to the transport pipe 10. The embodiment provides a hydrogen gas transport apparatus that overcomes such disadvantage described above.

### [Hydrogen Gas Transport Apparatus According to the Embodiment]

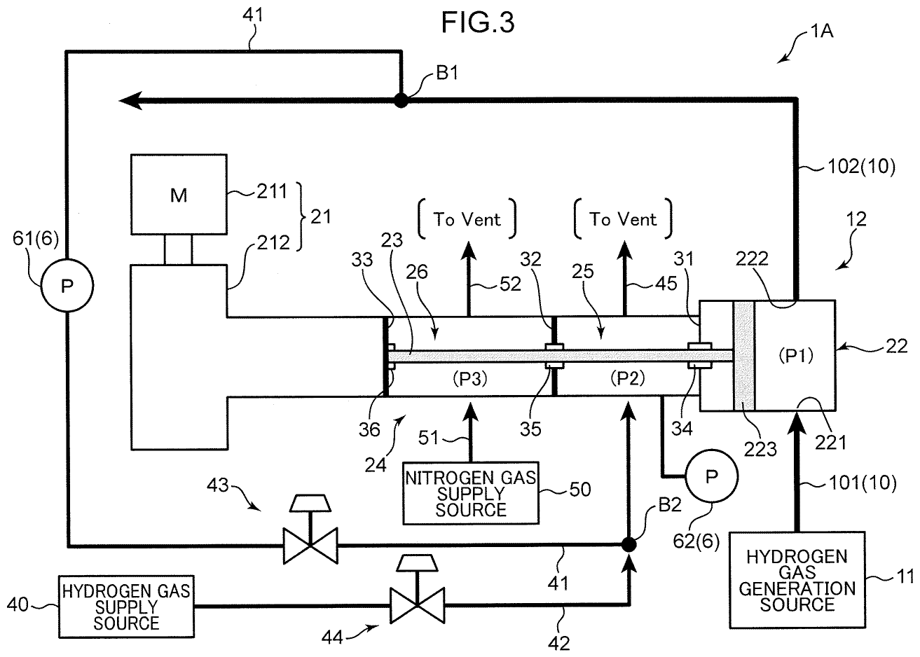

FIG. 3 is a system diagram illustrating a configuration of a hydrogen gas transport apparatus 1A including a compressor 12 having a purging structure in the embodiment. The compressor 12 includes a drive source 21, a compression chamber 22, a drive shaft 23, and a housing 24. The housing 24 has a first purging chamber 25 and a second purging chamber 26, and further a first partition 31, a second partition 32, and a third partition 33 each defines the chambers. The drive shaft 23 is provided with a first shaft seal 34 at a penetration portion of the drive shaft through the first partition 31, a second shaft seal 35 at a penetrating portion of the drive shaft through the second partition 32, and a third shaft seal 36 at a penetrating portion of the drive shaft through the third partition 33. This configuration is similar to the configuration about the compressor 120 in the comparative example, and thus, explanation for the configuration will be omitted.

The hydrogen gas transport apparatus 1A includes: two purging pipes of a first purging pipe 41 and a second purging pipe 42 to each send hydrogen gas as purge gas to the first purging chamber 25; and a third purging pipe 51 to send nitrogen gas as purge gas to the second purging chamber 26. The hydrogen gas transport apparatus 1A further includes: a first automatic valve 43 incorporated in the first purging pipe 41; a second automatic valve 44 incorporated in the second purging pipe 42; a hydrogen gas supply source 40; a nitrogen gas supply source 50; a first pressure sensor 61; and a second pressure sensor 62 or detector.

The first purging pipe 41 is similar to the hydrogen gas purging pipe 410 in the comparative example described above. The first purging pipe 41 branches from the transport pipe 10 at a branch section B1 of the transport pipe 10 that is located at a downstream pipe 102 at a downstream position of the compressor 12. The first purging pipe 41 has a downstream end connected to an introduction opening at the first purging chamber 25.

The first pressure sensor 61 is attached to the first purging pipe 41. The first pressure sensor 61 measures a gas pressure of the hydrogen gas passing through the first purging pipe 41. The pressure measured by the first pressure sensor 61 corresponds to a process line pressure in the transport pipe 10, and corresponds to the pressure P1 in the compression chamber 22. Opening and closing of the first automatic valve 43 enable switching between supply and suspension of the supply of hydrogen gas from the first purging pipe 41 to the first purging chamber 25.

The second purging pipe 42 can supply hydrogen gas to the first purging chamber 25 independently of the first purging pipe 41. The second purging pipe 42 is provided to supply hydrogen gas to the first purging chamber 25 at a pressure reduction in the downstream pipe 102 of the transport pipe 10, that is, at a reduction in the pressure P1 in the compression chamber 22, due to suspension of the compressor 12 or a reduction in the sending-out pressure from the compressor 12. In other words, the second purging pipe 42 works as a substitute to supply the hydrogen gas for purging to the first purging chamber 25 when the first purging pipe 41 is unavailable to supply the hydrogen gas due to suspension of the compressor 12 or other factor.

The second purging pipe 42 has an upstream end connected to the hydrogen gas supply source 40 that enables supply of hydrogen gas for purging. The hydrogen gas supply source 40 indicates another transport pipe for hydrogen gas except the downstream pipe 102 from which the first purging pipe 41 branches, a hydrogen gas tank, or other source. The second purging pipe 42 has a downstream end connected to a joining section B2 of the first purging pipe 41 located at a downstream position of the first automatic valve 43. Of course, the downstream end of the second purging pipe 42 may be directly connected to the introduction opening of the first purging chamber 25. Opening and closing of the second automatic valve 44 enable switching between supply and suspension of the supply of the hydrogen gas from the second purging pipe 42 to the first purging chamber 25.

The third purging pipe 51 is similar to the nitrogen gas purging pipe 510 in the comparative example described above. The second purging chamber 26 receives supply of nitrogen gas as purge gas from the nitrogen gas supply source 50 through the third purging pipe 51.

The second pressure sensor 62 is attached to the first purging chamber 25. The second pressure sensor 62 measures the pressure P2 in the first purging chamber 25. The first pressure sensor 61 is excludable. In this regard, the arrangement of both the first pressure sensor 61 that directly measures the process line pressure and the second pressure sensor 62 that directly measures the pressure P2 in the first purging chamber 25 enables prompt measurement of a pressure reduction attributed to suspension of operation of a device or other factor, resulting in appropriate control of opening and closing the first automatic valve 43 and the second automatic valve 44.

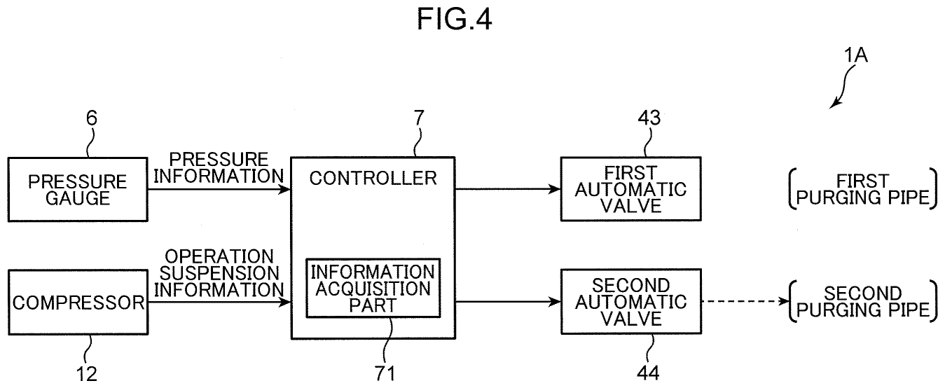

FIG. 4 is a block diagram illustrating a control configuration of the hydrogen gas transport apparatus 1A. The hydrogen gas transport apparatus 1A includes a controller 7 that controls operation of supply of the hydrogen gas for purging to the first purging chamber 25. The controller 7 changes a passage to supply the hydrogen gas for purging to the first purging chamber 25 by controlling each of the first automatic valve 43 at the first purging pipe 41 and the second automatic valve 44 at the second purging pipe 42 to close or open.

The controller 7 includes a processor that operates in response to execution of a program, and operatively has a information acquisition part 71. The information acquisition part 71 acquires pressure information from a pressure sensor 6 (the first pressure sensor 61 and/or the second pressure sensor 62). The information acquisition part 71 further acquires operation suspension information from the compressor 12. The pressure information includes data of the pressure in the first purging pipe 41 or data of the pressure in the first purging chamber 25, the pressure being measured by the pressure sensor 6. The operation suspension information includes any information showing detection that the compressor 12 reaches suspension of operation, such as an operation suspension signal from the prime mover 211, a detection signal from a rotation angle sensor attached to a crank mechanism of the crank chamber 212, or other information.

The controller 7 controls the first automatic valve 43 and the second automatic valve 44 to open or close with reference to one of or both the pressure information and the operation suspension information. The controller 7 reverses an opened or closed state of each of the first automatic valve 43 and the second automatic valve 44 depending on a normal operation or an abnormal operation of the compressor 12. The normal operation means that the compressor 12 is in an operation state and a result of measurement by the pressure sensor 6 shows a normal sending-out pressure from the compressor 12. The abnormal operation means that the compressor 12 reaches an operation suspension state, or the sending-out pressure from the compressor 12 reduces to a value lower than a predetermined threshold.

At the normal operation, the controller 7 controls the first automatic valve 43 to “open” and controls the second automatic valve 44 to “close”. In other words, the first purging pipe 41 is caused to supply the hydrogen gas for purging therefrom to the first purging chamber 25. The supply pressure of the hydrogen gas for purging to the first purging chamber 25 is selected to satisfy the relation of “P1>P2>P3” described above. At the normal operation, the second purging pipe 42 is suspended.

At the abnormal operation, the controller 7 controls the first automatic valve 43 to “close” and controls the second automatic valve 44 to “open”. That is to say, the second purging pipe 42 is caused to supply the hydrogen gas for purging therefrom to the first purging chamber 25 in cooperation with the hydrogen gas supply source 40. A supply pressure of the hydrogen gas for purging to the first purging chamber 25 is set so that the relation of “P1>P2>P3” described above is maintained even in such a change to a route through the second purging pipe 42 for supply of the hydrogen gas. The setting allows each of the first shaft seal 34 and the second shaft seal 35 to receive the same gas pressure as the gas pressure at the normal operation, and thus results in achieving deterrence of entering of the nitrogen gas into the compression chamber 22.

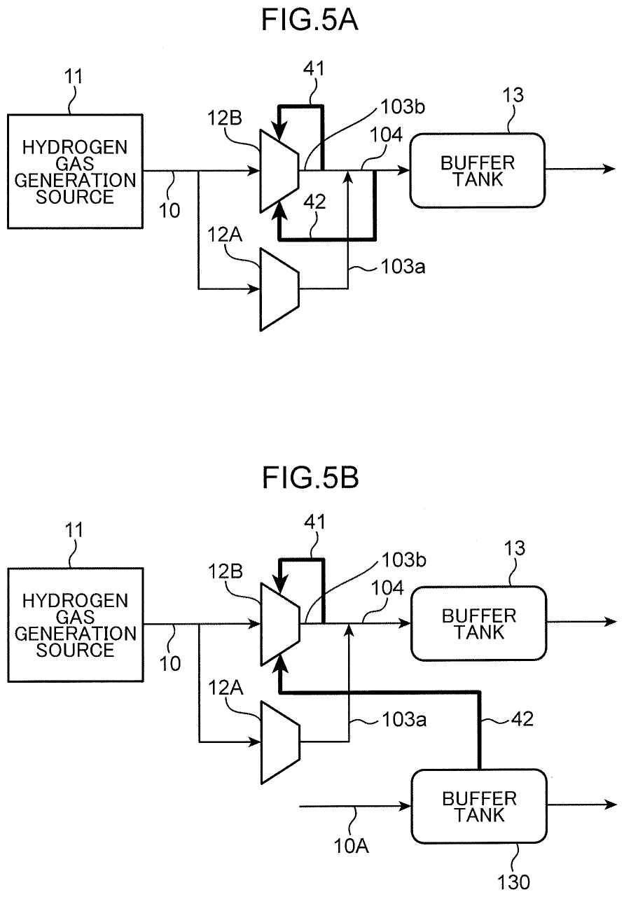

The hydrogen gas supply source 40 may be a hydrogen gas tank arranged independently of the system of the transport pipe 10. In this regard, the hydrogen gas transport apparatus 1A including the plural compressors 12 like the embodiment desirably makes the system of the transport pipe 10 of the apparatus serve as the hydrogen gas supply source 40. FIG. 5A and FIG. 5B are each a system diagram illustrating an example arrangement of the second purging pipe 42 that supplies hydrogen gas for purging in the system of the transport pipe 10. Each drawing exemplifies only the arrangement of the first purging pipe 41 and the second purging pipe 42 relative to the second compressor 12B to work as the emergency-use compressor.

The transport pipe 10 has a first downstream pipe 103a and a second downstream pipe 103b being individual and respectively located at a downstream position of the first compressor 12A and at a downstream position of the second compressor 12B. The transport pipe 10 further has a confluent pipe 104 at downstream positions of the first and second downstream pipes 103a and 103b where the downstream pipes meet to combine.

FIG. 5A exemplifies the confluent pipe 104 as a hydrogen gas supply source for the second purging pipe 42 for the second compressor 12B. The first purging pipe 41 for the second compressor 12B branches from the second downstream pipe 103b at a downstream position of the second compressor 12B and extends to the first purging chamber 25 of the compressor 12B. This configuration is the same as the configuration in the embodiment as illustrated in FIG. 3. By contrast, the second purging pipe 42 for the second compressor 12B branches from the confluent pipe 104 and extends to the first purging chamber 25 of the second compressor 12B.

For example, in transition from the state where both the first compressor 12A and the second compressor 12B are operated to the state of the normal operation for loading, the second compressor 12B working as the emergency-use compressor is suspended. In the example, the supply of the hydrogen gas for purging from the first purging pipe 41 to the first purging chamber 25 is suspended. By contrast, hydrogen gas (BOG) continues to flow to the confluent pipe 104 even after transition to such a single operation state by the first compressor 12A for regular-use. The second purging pipe 42 branching from the confluent pipe 104 hence enables supply of the hydrogen gas for purging therefrom to the first purging chamber 25. Accordingly, the purging state in the first purging chamber 25 is maintainable.

FIG. 5B exemplifies another transport pipe 10A as a hydrogen gas supply source for the second purging pipe 42 for the second compressor 12B. The first purging pipe 41 branches from the second downstream pipe 103b for the second compressor 12B. The second purging pipe 42 branches from a buffer tank 130 incorporated in the another transport pipe 10A and extends to the first purging chamber 25 of the second compressor 12B. The configuration enables supply of the hydrogen gas for purging from the buffer tank 130 at the another transport pipe 10A to the first purging chamber 25 through the second purging pipe 42 even after transition from a parallel operation state of the first compressor 12A and the second compressor 12B to the single operation state of the first compressor 12A.

The hydrogen gas transport apparatus 1A according to the embodiment described heretofore includes, in addition to the first purging pipe 41 branching from the transport pipe 10, the second purging pipe 42 that defines a route for supply of the hydrogen gas for purging to the first purging chamber 25 and works at a pressure reduction in the transport pipe 10. This configuration having the route through the second purging pipe 42 enables compensation for possible interruption of the supply of the hydrogen gas for purging from the first purging pipe 41 to the first purging chamber 25 due to some circumstances, such as a reduced output from or suspension of the compressor 12. This consequently achieves deterrence of entering of the nitrogen gas from the second purging chamber 26 into the compression chamber 22 or the transport pipe 10 through the first shaft seal 34 and the second shaft seal 35.

### Modifications

The preferable embodiment of the present disclosure has been described heretofore, but the disclosure is not limited to the embodiment. For instance, the following modified embodiments may be adopted.

(1) The embodiment shows the example that the first purging pipe 41 is provided with the first automatic valve 43 and the second purging pipe 42 is provided with the second automatic valve 44, and the controller 7 controls each valve to open and close. A manual valve may be adopted in place of each of the first automatic valve 43 and the second automatic valve 44. In this case, notification is made with an alarm, a sound, an image, or other way in detection of a pressure reduction in the transport pipe 10 to encourage an operator to open or close the valve.

(2) The embodiment exemplifies incorporation of the two compressors of the first compressor 12A and the second compressor 12B in the transport pipe 10 in parallel manner. A single compressor may be incorporated in the transport pipe 10. In this case, the second purging pipe 42 receives supply of hydrogen gas from the hydrogen gas supply source 40 branching from another transport pipe being independent of the transport pipe 10, or from an independent hydrogen gas supply source 40.

(3) The embodiment exemplifies the compressor 12 of a reciprocating type, and the first purging chamber 25 and the second purging chamber 26 defined as enclosed spaces separated from each other. For instance, in a case where a centrifugal compressor is adopted as the compressor 12, each of the first purging chamber 25 and the second purging chamber 26 may have an opening portion at a part thereof.

(4) The embodiment exemplifies supply of hydrogen gas from the hydrogen gas generation source 11 as a way of supplying the hydrogen gas to the transport pipe 10. The transport pipe 10 may be a pipe to circulate the hydrogen gas. For instance, in the liquefier 15 for the hydrogen gas, a pipe to circulate the hydrogen gas as a coolant may be defined as the transport pipe 10, a compressor may be arranged at the pipe for circulation, and the purging structure in the embodiment may be applied to the compressor.

### SUMMARY OF THE DISCLOSURE

The embodiments described in detail heretofore cover the disclosure including the following configurations.

A hydrogen gas transport apparatus according to a first feature of the present disclosure includes: a transport pipe for hydrogen gas; a compressor that is located at the transport pipe and sends out the hydrogen gas. The compressor includes: a drive source; a compression chamber that includes a compression element for the hydrogen gas and is connected to the transport pipe; a drive shaft that connects the drive source and the compression element to each other; and a housing that accommodates the drive shaft, the housing having a first purging chamber that is adjacent to the compression chamber and receives supply of the hydrogen gas as purge gas, a second purging chamber that is adjacent to the first purging chamber and receives supply of inert gas as purge gas, a first partition that separates the compression chamber and the first purging chamber from each other, and a second partition that separates the first purging chamber and the second purging chamber from each other, the drive shaft penetrating through the first partition and the second partition and being provided with a first shaft seal at a penetration portion of the drive shaft through the first partition and a second shaft seal at a penetration portion of the drive shaft through the second partition. The hydrogen gas transport apparatus includes: a detector that detects a pressure reduction in the transport pipe; a first purging pipe that branches from the transport pipe and supplies the hydrogen gas to the first purging chamber; a second purging pipe that supplies the hydrogen gas from a predetermined hydrogen gas supply source to the first purging chamber when the detector detects the pressure reduction; and a third purging pipe that supplies the inert gas to the second purging chamber.

In the first feature, the apparatus includes, in addition to the first purging pipe branching from the transport pipe, the second purging pipe that defines a route for supply of the hydrogen gas as the purge gas to the first purging chamber and works at a pressure reduction in the transport pipe. The configuration having the route through the second purging pipe enables compensation for possible interruption of the supply of the hydrogen gas from the first purging pipe to the first purging chamber due to some circumstances, such a reduced output from or suspension of the compressor. This consequently achieves deterrence of entering of the inert gas from the second purging chamber into the compression chamber or the transport pipe through the first shaft seal and the second shaft seal.

In the hydrogen gas transport apparatus according to a second feature, in the first feature of the hydrogen gas transport apparatus, the compressor is of a reciprocating type, the drive source includes a reciprocating mechanism that converts a rotational movement of a prime mover into a reciprocating movement, the compression chamber includes a piston that serves as the compression element and reciprocates, and the drive shaft connects the reciprocating mechanism and the piston to each other.

The second feature achieves deterrence of entering of the inert gas serving as the purge gas into the compression chamber where the piston reciprocates in the compressor of the reciprocating type. This configuration thus prevents such a fault that the piston fails to slidably move due to freezing of the inert gas.

In the hydrogen gas transport apparatus according to a third feature, in the first or second feature of the hydrogen gas transport apparatus, the detector includes a pressure sensor that detects a pressure in the first purging chamber or a pressure in the first purging pipe.

The third feature enables an immediate grasp of a state of a reduction in the purging effect due to a pressure reduction in the transport pipe on the basis of a measurement result by the pressure sensor.

In the hydrogen gas transport apparatus according to a fourth feature, in the first or second feature of the hydrogen gas transport apparatus, the detector includes an information acquisition part that acquires information about operation suspension of the compressor.

Such operation suspension of the compressor is directly linked to a pressure reduction in the transport pipe. The fourth feature enables an immediate grasp of a state of a reduction in the purging effect on the basis of the suspension information about the compressor acquired by the information acquisition part.

In the hydrogen gas transport apparatus according to a fifth feature, in the first to fourth features of the hydrogen gas transport apparatus, the hydrogen gas supply source includes another transport pipe provided with a compressor, or a confluent pipe where the transport pipe and the another transport pipe meet to combine, and the second purging pipe branches from the transport pipe or the confluent pipe at a downstream position of the compressor.

The hydrogen gas flowing in the transport pipe has a higher pressure at a downstream position of the compressor. The fifth feature enables facilitated supply of the hydrogen gas having a predetermined purging pressure from the second purging pipe to the first purging chamber. The configuration further reliably keeps the hydrogen gas supply source for the second purging pipe at a closer location.

In the hydrogen gas transport apparatus according to a sixth feature, in the first to fifth features of the hydrogen gas transport apparatus, a pressure in the compression chamber is defined as P1, a pressure in the first purging chamber is defined as P2, and a pressure in the second purging chamber is defined as P3, and a supply pressure of the hydrogen gas is selected to maintain a relation of “P1>P2>P3” during operation without change at supply of the hydrogen gas from one of the first purging pipe and the second purging pipe to the first purging chamber.

The sixth feature in which the pressure relation of “P1>P2>P3” is always maintained during the operation of the hydrogen gas transport apparatus enables reliable prevention of entering of the inert gas into the compression chamber.

A purging method for a compressor according to a seventh feature of the present disclosure is a purging method for a compressor that is provided at a transport pipe for hydrogen gas and sends out the hydrogen gas. The compressor includes: a drive source; a compression chamber that includes a compression element for the hydrogen gas and is connected to the transport pipe; a drive shaft that connects the drive source and the compression element to each other; and a housing that accommodates the drive shaft, the housing having a first purging chamber that is adjacent to the compression chamber and receives supply of the hydrogen gas as purge gas, a second purging chamber that is adjacent to the first purging chamber and receives supply of inert gas as purge gas, a first partition that separates the compression chamber and the first purging chamber from each other, and a second partition that separates the first purging chamber and the second purging chamber from each other, the drive shaft penetrating through the first partition and the second partition and being provided with a first shaft seal at a penetration portion of the drive shaft through the first partition and a second shaft seal at a penetration portion of the drive shaft through the second partition. The purging method includes: supplying the hydrogen gas to the first purging chamber from a first purging pipe branching from the transport pipe when no pressure reduction is detected in the transport pipe; supplying the hydrogen gas to the first purging chamber from a second purging pipe communicating with a predetermined hydrogen gas supply source when a pressure reduction is detected in the transport pipe; and supplying inert gas to the second purging chamber through a third purging pipe.

In the seventh feature, the route through the second purging pipe enables compensation for possible interruption of the supply of the hydrogen gas from the first purging pipe to the first purging chamber. This consequently achieves deterrence of entering of the inert gas from the second purging chamber into the compression chamber or the transport pipe through the first shaft seal and the second shaft seal.

### DESCRIPTION FOR REFERENCE SIGNS

1 hydrogen gas transport line
1A hydrogen gas transport apparatus
10 transport pipe
11 hydrogen gas generation source
12 compressor
12A, 12B first, second compressor
21 drive source
212 crank chamber (reciprocating mechanism)
22 compression chamber
223 piston (compression element)
23 drive shaft
24 housing
25 first purging chamber
26 second purging chamber
31 first partition
32 second partition
34 first shaft seal
35 second shaft seal
40 hydrogen gas supply source
41 first purging pipe
42 second purging pipe
6 pressure gauge
61, 62, first, second pressure sensor (detector)
7 controller
71 information acquisition part (detector)

1. A hydrogen gas transport apparatus, comprising:
a transport pipe for hydrogen gas;
a compressor that is located at the transport pipe and sends out the hydrogen gas, the compressor including:
a drive source;
a compression chamber that includes a compression element for the hydrogen gas and is connected to the transport pipe;
a drive shaft that connects the drive source and the compression element to each other; and
a housing that accommodates the drive shaft,
the housing having a first purging chamber that is adjacent to the compression chamber and receives supply of the hydrogen gas as purge gas, a second purging chamber that is adjacent to the first purging chamber and receives supply of inert gas as purge gas, a first partition that separates the compression chamber and the first purging chamber from each other, and a second partition that separates the first purging chamber and the second purging chamber from each other,
the drive shaft penetrating through the first partition and the second partition and being provided with a first shaft seal at a penetration portion of the drive shaft through the first partition and a second shaft seal at a penetration portion of the drive shaft through the second partition;
a detector that detects a pressure reduction in the transport pipe;
a first purging pipe that branches from the transport pipe and supplies the hydrogen gas to the first purging chamber;
a second purging pipe that supplies the hydrogen gas from a predetermined hydrogen gas supply source to the first purging chamber when the detector detects the pressure reduction; and
a third purging pipe that supplies the inert gas to the second purging chamber.

2. The hydrogen gas transport apparatus according to claim 1, wherein the compressor is of a reciprocating type, the drive source includes a reciprocating mechanism that converts a rotational movement of a prime mover into a reciprocating movement, the compression chamber includes a piston that serves as the compression element and reciprocates, and the drive shaft connects the reciprocating mechanism and the piston to each other.

3. The hydrogen gas transport apparatus according to claim 1, wherein the detector includes a pressure sensor that detects a pressure in the first purging chamber or a pressure in the first purging pipe.

4. The hydrogen gas transport apparatus according to claim 1, wherein the detector includes an information acquisition part that acquires information about operation suspension of the compressor.

5. The hydrogen gas transport apparatus according to claim 1, wherein the hydrogen gas supply source includes another transport pipe provided with a compressor, or a confluent pipe where the transport pipe and the another transport pipe meet to combine, and
the second purging pipe branches from the transport pipe or the confluent pipe at a downstream position of the compressor.

6. The hydrogen gas transport apparatus according to claim 1, wherein a pressure in the compression chamber is defined as P1, a pressure in the first purging chamber is defined as P2, and a pressure in the second purging chamber is defined as P3, and
a supply pressure of the hydrogen gas is selected to maintain a relation of “P1>P2>P3” during operation without change at supply of the hydrogen gas from one of the first purging pipe and the second purging pipe to the first purging chamber.

7. A purging method for a compressor that is provided at a transport pipe for hydrogen gas and sends out the hydrogen gas, the compressor including:
a drive source;
a compression chamber that includes a compression element for the hydrogen gas and is connected to the transport pipe;
a drive shaft that connects the drive source and the compression element to each other; and
a housing that accommodates the drive shaft,
the housing having a first purging chamber that is adjacent to the compression chamber and receives supply of the hydrogen gas as purge gas, a second purging chamber that is adjacent to the first purging chamber and receives supply of inert gas as purge gas, a first partition that separates the compression chamber and the first purging chamber from each other, and a second partition that separates the first purging chamber and the second purging chamber from each other,
the drive shaft penetrating through the first partition and the second partition and being provided with a first shaft seal at a penetration portion of the drive shaft through the first partition and a second shaft seal at a penetration portion of the drive shaft through the second partition, the purging method comprising:
supplying the hydrogen gas to the first purging chamber from a first purging pipe branching from the transport pipe when no pressure reduction is detected in the transport pipe;
supplying the hydrogen gas to the first purging chamber from a second purging pipe communicating with a predetermined hydrogen gas supply source when a pressure reduction is detected in the transport pipe; and
supplying inert gas to the second purging chamber through a third purging pipe.

8. The hydrogen gas transport apparatus according to claim 2, wherein a pressure in the compression chamber is defined as P1, a pressure in the first purging chamber is defined as P2, and a pressure in the second purging chamber is defined as P3, and
a supply pressure of the hydrogen gas is selected to maintain a relation of “P1>P2>P3” during operation without change at supply of the hydrogen gas from one of the first purging pipe and the second purging pipe to the first purging chamber.

9. The hydrogen gas transport apparatus according to claim 3, wherein a pressure in the compression chamber is defined as P1, a pressure in the first purging chamber is defined as P2, and a pressure in the second purging chamber is defined as P3, and
a supply pressure of the hydrogen gas is selected to maintain a relation of “P1>P2>P3” during operation without change at supply of the hydrogen gas from one of the first purging pipe and the second purging pipe to the first purging chamber.

10. The hydrogen gas transport apparatus according to claim 4, wherein a pressure in the compression chamber is defined as P1, a pressure in the first purging chamber is defined as P2, and a pressure in the second purging chamber is defined as P3, and
a supply pressure of the hydrogen gas is selected to maintain a relation of “P1>P2>P3” during operation without change at supply of the hydrogen gas from one of the first purging pipe and the second purging pipe to the first purging chamber.

11. The hydrogen gas transport apparatus according to claim 5, wherein a pressure in the compression chamber is defined as P1, a pressure in the first purging chamber is defined as P2, and a pressure in the second purging chamber is defined as P3, and
a supply pressure of the hydrogen gas is selected to maintain a relation of “P1>P2>P3” during operation without change at supply of the hydrogen gas from one of the first purging pipe and the second purging pipe to the first purging chamber.
